(19) United States
(12) Patent Application Publication
(10) Pub. No.: US 2025/0249611 A1
(43) Pub. Date: Aug. 7, 2025

(54) UTILITY KNIFE WITH RETRACTABLE LANYARD

(71) Applicant: Dame Good Ideas LLC, Loveland, CO (US)

(72) Inventor: Claudia Sager, Loveland, CO (US)

(21) Appl. No.: 19/045,738

(22) Filed: Feb. 5, 2025

Related U.S. Application Data
(60) Provisional application No. 63/550,763, filed on Feb. 7, 2024.

(51) Int. Cl. B26B 5/00; A45F 5/00; A45F 5/02; B26B 29/02

(52) U.S. Cl. CPC B26B 5/003; A45F 5/004; A45F 5/02; A45F 5/1575; B26B 29/02; A45F 2005/006

(57) ABSTRACT

A utility knife or other small tool with retractable lanyard is disclosed. An example utility knife tool with retractable lanyard includes a tool body having a handle and a blade. A reel is associated with the tool body (e.g., integrated with or connected to), and has a self-retracting mechanism. A lanyard is configured to at least partially unspool from the reel as the tool body is pulled away from the reel, thereby applying tension to the lanyard. The lanyard is also configured to at least partially spool back onto the reel automatically when the tension applied to the lanyard is lessened or fully released. An attachment mechanism on the lanyard is configured to associate the tool body with a person or article associated with the person via the lanyard so that the person can readily locate the tool body for use without having to search for the tool body.

### PRIORITY CLAIM

This application claims the priority filing benefit of U.S. Provisional Patent Application No. 63/550,763 filed Feb. 7, 2024 for “Utility Knife With Retractable Lanyard” of Claudia Sager, hereby incorporated by reference in its entirety as though fully set forth herein.

### BACKGROUND

Anyone working in the construction industry, home repair industry, and even do-it-yourself (DYI) homeowners, often find themselves using small tools such as utility knives on a frequent basis. It is fairly typical for the user to need the utility knife, then have to set it down while doing something else, and then pick it up and continue using the utility knife. The utility knife may get misplaced (e.g., under something, or left up on a ladder after the user climbs down) and thus “lost”. The time it takes to find the “lost” utility knife introduces lost time on the project. While utility knives and other small tools can be kept in a pocket, the user needs to remember to retract the blade each time so that they do not cut themselves. Even keeping these in a utility belt or tool pouch can introduce delays to the project at hand as the user has to search around to find the tool within their utility belt or tool pouch. A simpler solution is needed.

### BRIEF DESCRIPTION OF THE DRAWINGS

FIG. 1 is an isometric view of an example utility knife with retractable lanyard.

FIG. 2 shows the example utility knife with retractable lanyard as it may be attached to a toolbelt.

FIG. 3 shows the example utility knife with retractable lanyard as it may be attached to a hook.

FIG. 4 is a side view of the example utility knife with retractable lanyard.

FIGS. 5-6 are side views of the example utility knife with retractable lanyard with a side removed so that operation of internal mechanisms are visible.

FIG. 7 is an isometric view of the example utility knife with retractable lanyard corresponding to FIG. 5.

FIG. 8 shows another example retraction mechanism for the example utility knife with retractable lanyard.

FIG. 9 shows an example hood mechanism for the example utility knife with retractable lanyard.

### DETAILED DESCRIPTION

An example utility knife with retractable lanyard is disclosed which provides the convenience of having the tool right by your side without having to place it somewhere nearby, risking having the tool drop or get “lost” and thus saving the user time to retrieve or locate the tool during use.

A utility knife is a versatile cutting tool designed for a wide range of tasks, often used in industries such as construction, crafting, and packaging. It typically includes a sharp, replaceable blade housed within a durable handle, which can be made of materials like plastic, metal, or rubber for enhanced grip and comfort. Some utility knives feature additional mechanisms such as blade release buttons for easy blade changes, retractable blades for safety, and ergonomic handles for better control. The scope of the invention should not be limited to implementation with any particular type of utility knife.

While the tool with retractable lanyard is shown and described herein as it may be implemented with a utility knife, it will be appreciated by those having ordinary skill in the art after becoming familiar with the teachings herein that the retractable lanyard may be implemented with various types and/or configurations of utility knives. Alternatives to traditional utility knives, which may also be provided with a retractable lanyard, include but are not limited to box cutters, which are similar but generally more compact and specialized for opening packages; hobby knives, which offer precise control for detailed work in crafts and models; and multi-tools, which combine various functions including cutting, screwing, and opening into a single portable device. Indeed, the scope of the invention should not be limited to implementation with a utility knife, as other small or handheld tools (e.g., hammer, power drill, etc.) are also suitable.

The utility knife, or other tool, may include a retractable lanyard. A retractable lanyard can be a cord or strap or coiled line designed to hold and secure the tool with which it is provided. A retractable mechanism allows the cord to extend and retract smoothly. It is provided in a durable housing, e.g., on a spring-loaded reel that manages the extension and retraction of the cord. An attachment mechanism such as a clip, ring, or hook can be provided at the end of the lanyard. The retractable feature ensures that the lanyard remains tidy and organized, preventing tangling and reducing wear and tear.

While the retractable lanyard is shown and described herein as it may be implemented as a particular type of retraction mechanism, it will be appreciated by those having ordinary skill in the art after becoming familiar with the teachings herein that the retractable lanyard may be implemented with other retraction mechanisms. Therefore, the scope of the invention should not be limited to implementation with any particular type of retraction mechanism except to the extent such limitation is recited in the claims.

Before continuing, it is noted that as used herein, the terms “includes” and “including” mean, but is not limited to, “includes” or “including” and “includes at least” or “including at least.” The term “based on” means “based on” and “based at least in part on.”

It is also noted that the examples described herein are provided for purposes of illustration, and are not intended to be limiting. Other devices and/or device configurations may be utilized to carry out the operations described herein.

The operations shown and described herein are provided to illustrate example implementations. It is noted that the operations are not limited to the ordering shown. Still other operations may also be implemented.

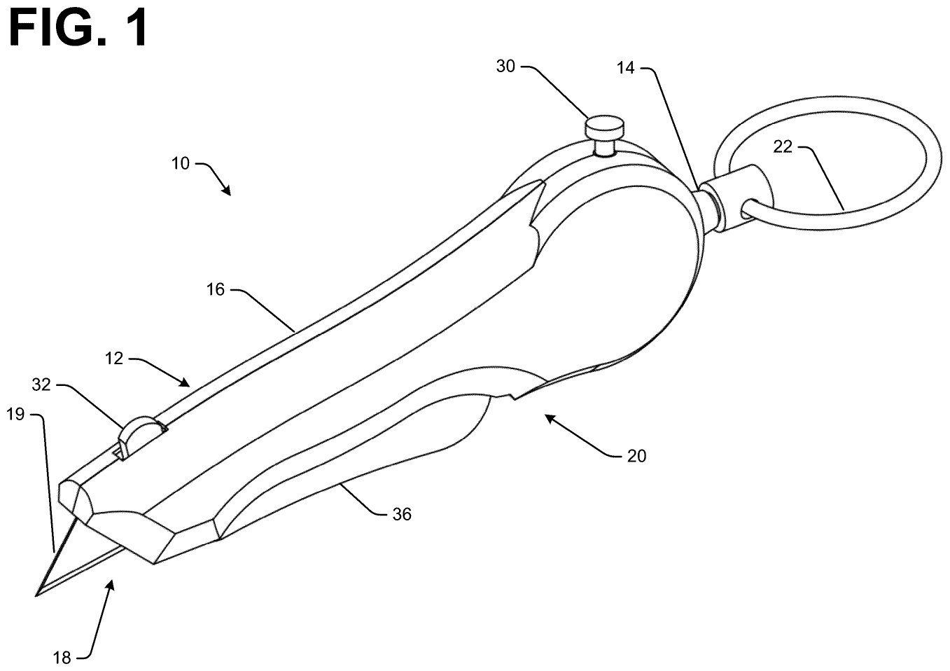

FIG. 1 is an isometric view of a device 10 having a utility knife or other tool 12 with retractable lanyard 14. The example utility knife 12 with retractable lanyard 14 includes a tool body 16 having an operating end or portion 18 and a handle end or portion 20. The operating end 18 of the tool body 16 houses the working components, such as the blade 19 or other functional elements. The handle end 20 is designed for a comfortable grip and enables the user to grasp or hold the device 10.

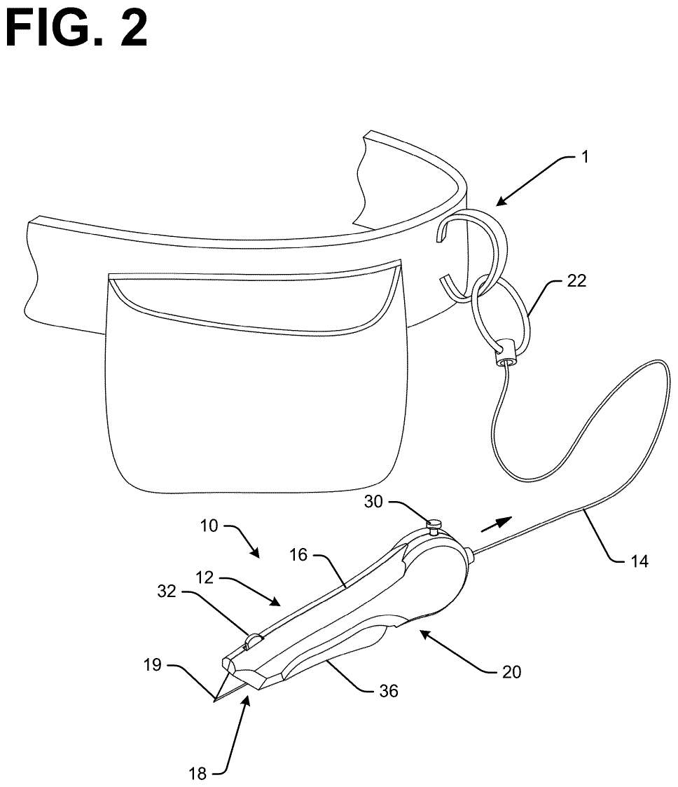

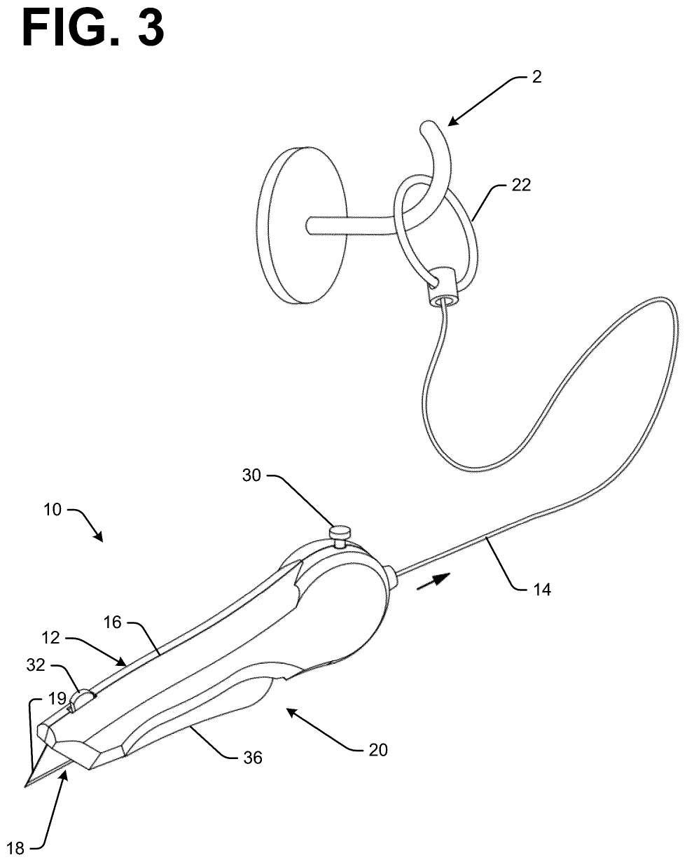

The retractable lanyard 14 is integrated within or otherwise connected to the tool body 16. The retractable lanyard 14 also includes a ring, clip, or other attachment means 22 for attaching to a tool belt (e.g., see tool belt 1 FIG. 2) or otherwise removably attaching to the user, or attaching to something associated with or near the user (e.g., see hook 2 in FIG. 3) so that the user can readily locate the utility knife or other small tool when needed.

In an example, the lanyard 14 is provided inside of the tool body 16 and an end of the lanyard 14 extends out from within the tool body 16, as can be seen in FIG. 1. The lanyard 14 can have a length (e.g., about 2-4 feet) that permits the attachment mechanism 22 to remain connected to the person or article associated with the person while the person uses the tool. In an example, the article associated with the person is a clothing article (e.g., belt, pants, jacket, etc.) worn by the person, or a stationary or semi-stationary object (e.g., a ladder, bucket, saw, etc.) near the person or the person's work area.

The attachment mechanism 22 on the lanyard 14 is configured to associate the tool body 16 with a person or article associated with the person via the lanyard 14 so that the person can readily locate the device 10 for use without having to search the ground or other locations where it may have been left during use. In an example, the attachment mechanism 22 is a ring, or a clip. Other attachment mechanisms are also contemplated being within the scope of the disclosure herein, as will be readily appreciated by those having ordinary skill in the art after becoming familiar with the teachings herein.

A key feature of the device 10 is the retractable lanyard 14, which can be either integrated or built into the tool body 16. Providing the retractable lanyard 14 within the tool body offers a sleek and protected design. One end of the lanyard extends out from the tool, ready to be attached to the user or another object. By keeping the lanyard inside the tool body 16, it remains shielded from external elements that could potentially damage it, such as sharp objects or harsh working conditions. This internal storage also contributes to a streamlined appearance, reducing the risk of tangling or snagging on other items. In another example, the retractable lanyard 14 can be connected to or otherwise associated external to the tool body 16.

The retractable lanyard 14 not only enhances convenience but also contributes to safety by minimizing the risk of dropping the device 10. The attachment mechanism 22, such as a ring or clip, is designed to be robust and easy to use, ensuring that the device 10 remains securely fastened during both use and storage. The overall design aims to provide a practical and reliable solution for users who need quick and easy access to their tools. This is especially important in settings where losing the device 10 could cause interruptions and/or be hazardous to the work environment.

The length of the retractable lanyard 14 is configured to be sufficiently long to allow the ring or other attachment means 22 to remain connected to the user or associated items even while the device 10 is in use. This means that the user can operate the device 10 without needing to detach it from their person or the stationary object it is connected to. This continuous attachment not only enhances convenience but also reduces the chances of the device 10 being dropped or misplaced during operation, improving overall efficiency and safety.

The length of the lanyard 14 can be carefully calibrated to provide enough flexibility for comfortable use without compromising on its ability to retract smoothly. This ensures that the lanyard 14 can accommodate a range of movements and positions without causing any obstruction or inconvenience. The design takes into account various scenarios in which the device 10 might be used, providing a balanced combination of reach and retraction capability to meet the user's needs.

This design ensures that the user can always locate and access the device 10 quickly, reducing the likelihood of misplacing it. This feature is particularly valuable in dynamic working environments (e.g., construction sites) where tools are frequently moved around and/or can become lost under building materials, or dropped from a ladder, scaffolding, etc.

FIG. 2 shows the example device 10 including a utility knife 12 with retractable lanyard 14 as it may be attached to a toolbelt 1. FIG. 3 shows the example device 10 including a utility knife 12 with retractable lanyard 14 as it may be attached to a hook 2 (e.g., on a stepladder, toolbox, etc.). In an example, the retractable lanyard 14 is sufficiently long so as to allow the ring or other attachment 22 to remain connected to the user or something associated with the user even during use.

In an example, the lanyard 14 is a 32 inch fiberglass line that extends when pulled out, and retracts automatically (e.g., via a spring mechanism) when not in use, so as to maintain the device 10 near the user and/or in a known area (e.g., when it is attached to a ladder). In an example, the retractable lanyard 14 is provided inside of the tool body 16, and an end of the retractable lanyard 14 extends out from within the tool body 16. It is noted that the ring, clip, or other attachment means 22 can be connected in any suitable manner and to any suitable object, e.g., to a belt loop of the user, a ladder, or other stationary or semi-stationary object near the user's working area.

The attachment means 22 keeps the device 10 securely fastened to the user's person, ensuring that it is always within reach. This is particularly useful for workers who need to have their tools readily accessible at all times. It minimizes the chances of losing the tool and enhances overall efficiency. The attachment means 22 is designed to be robust and easy to use, allowing for quick and secure fastening and unfastening. It provides a reliable way to keep the device 10 close at hand without causing any inconvenience or discomfort to the user. This feature is ideal for professionals who need to frequently access their tools while on the move.

The attachment means 22 on the retractable lanyard 14 can also be connected to stationary or semi-stationary objects such as ladders or workstations, buckets, toolboxes, etc. that are near the user's work area. This functionality is particularly useful in environments where the user needs to have the tool within reach but prefers not to carry it on their person. By attaching the device 10 to a nearby object, the user can ensure that it remains easily accessible without the risk of misplacement. The attachment means 22 is especially valuable in scenarios where the user needs to move around a fixed work area, such as on a construction site or in a workshop. It allows for a hands-free approach while keeping the device 10 securely fastened and within easy reach. This enhances both convenience and productivity.

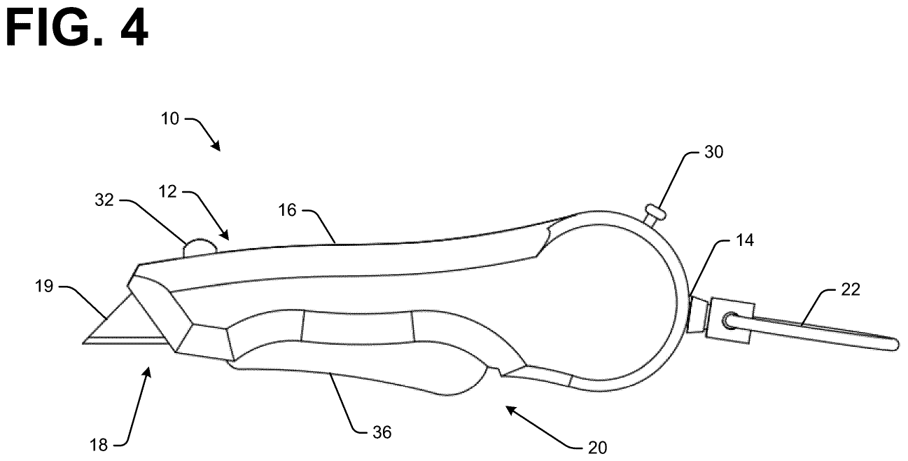

FIG. 4 is a side view of the example device 10 having a utility knife 12 with retractable lanyard 14. In an example, the device 10 includes a braking system, payout mechanism, and a retraction spring configured to keep the coiled line taught as the coiled line moves in and out of the tool body. The lanyard 14 may be configured as a coiled line that offers greater flexibility and durability, accommodating various movements without becoming tangled. As already discussed above, the device 10 enables the user to keep track of the tool being used by keeping it “on hand” to efficiently streamline work in progress without the user having to search for misplaced tools.

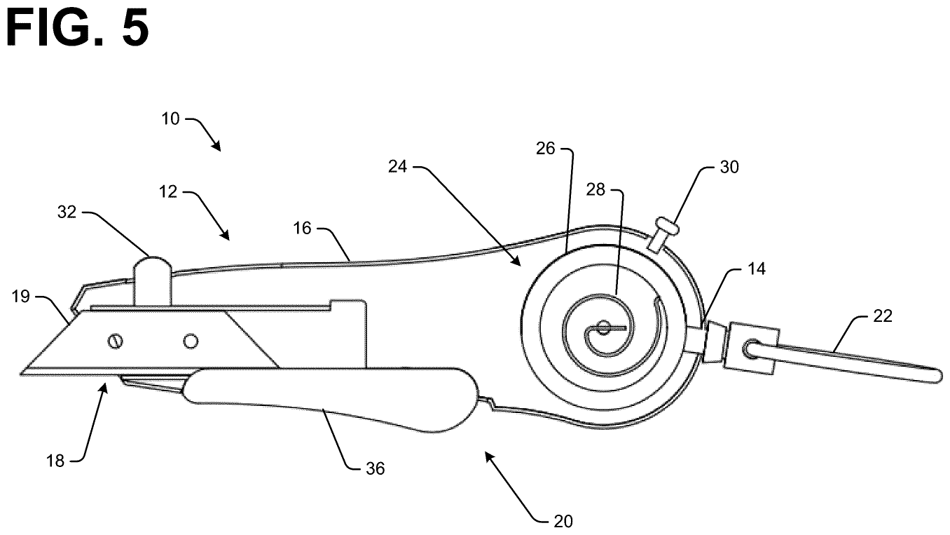

An example implementation includes several advanced features for the retractable lanyard 14. These may include, by way of illustration, a coiled line for additional flexibility, a braking system to control the lanyard's retraction speed, a payout mechanism to manage the length of the extended lanyard, and a retraction spring to keep the coiled line taut. These features are described in more detail with reference to FIGS. 5-7, and collectively ensure that the lanyard 14 operates smoothly and reliably, providing a seamless user experience.

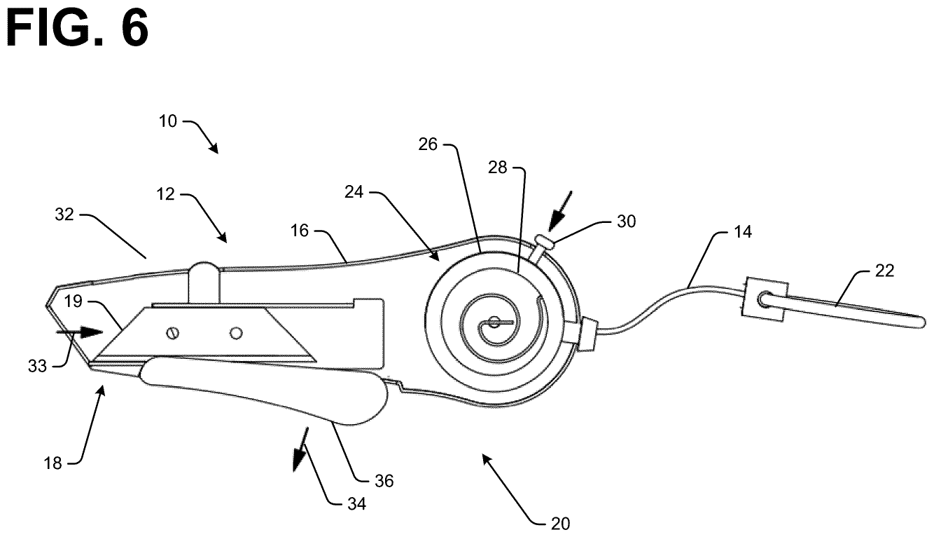

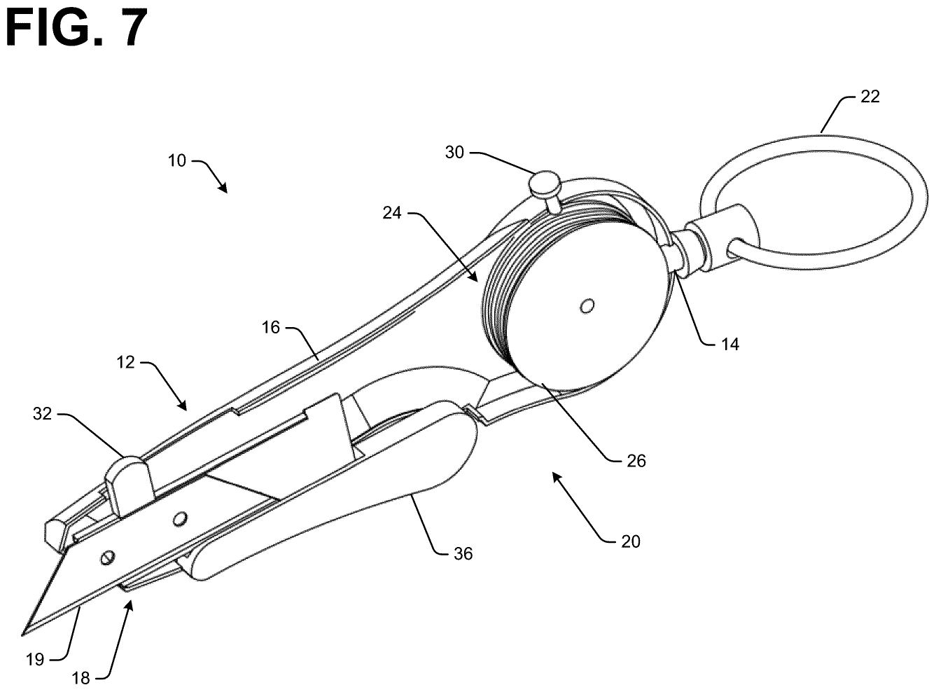

FIGS. 5-6 are side views of the example device 10 having a utility knife 12 with retractable lanyard 14, shown with a side of the tool body 16 removed so that internal mechanisms and operation thereof are visible. FIG. 7 is an isometric view of the example device 10 corresponding to FIG. 5. The internal housing of the lanyard 14 helps in maintaining the overall compactness and durability of the device 10. It ensures that the lanyard 14 is only exposed when needed, thereby extending its lifespan and reliability. This design approach makes the tool more user-friendly by eliminating the need for manual retraction and providing an organized and tidy solution for managing the lanyard.

In an example, the lanyard 14 is stored as a coiled line on a self-retracting mechanism 24. The self-retracting mechanism 24 has a reel or roller 26 on a spring 28 (also referred to herein as a spring roller), a braking system 30 to prevent the lanyard 14 from retracting during use (the braking system 30 is releasable after using the device 10), and a payout mechanism that allows the lanyard 14 to be unspooled under tension. The payout mechanism is embodied by the spring roller and is configured to keep the lanyard 14 taught as the lanyard 14 moves in and out of the tool body 16.

The roller or reel 26 is associated with (e.g., part of, integrated with, or attached to) the tool body 16, and operates under the spring 28 as a self-retracting mechanism. During use, the lanyard 14 is configured to at least partially unspool from the reel 26, thereby applying tension to the lanyard 14. The lanyard 14 is also configured to at least partially spool back onto the reel automatically (e.g., under operation of the spring 28) when the tension applied to the lanyard 14 is lessened or fully released.

In an example, the retractable lanyard 14 is provided on the spring roller to make it self-retracting. That is, the spring roller mechanism allows the lanyard 14 to self-retract back onto the reel 26 when the device 10 is not in use. This feature ensures that the lanyard 14 is automatically wound back onto the reel 26 within the tool body 16, keeping the device 10 tidy and ready for the next use without requiring manual intervention. The self-retracting mechanism is particularly useful for users who need to frequently deploy and store the device 10, as it can save time and effort.

Additionally, the spring roller mechanism provides consistent tension on the lanyard 14, ensuring that the lanyard 14 retracts smoothly and efficiently every time. This not only enhances usability of the device 10, but also reduces the risk of the lanyard 14 becoming tangled or damaged. The self-retracting feature adds a layer of convenience and reliability, making the tool more practical for various working environments.

In an example, the device 10 includes a blade release mechanism 32 for the razor blade 19 of the utility knife. In an example, the blade release mechanism 32 allows the user to hold the blade 19 in an extended position 19, as shown in FIG. 5, and to release the blade 19 to retract into the device housing 16 when not in use, as illustrated by arrows 33 and 34 shown in FIG. 6. The blade release mechanism 32 is particularly valuable for tasks that require different types of blades or frequent blade changes. The blade release mechanism is designed to be user-friendly, enabling quick and safe blade swaps without the need for additional tools. This adds versatility to the utility knife, making it suitable for a wide range of applications.

The blade release mechanism 32 also enhances safety by ensuring that the blade 19 is securely locked in place during use and can be safely retracted when not needed. This reduces the risk of accidental injuries and extends the life of the blade 19 by protecting it when not in use. As such, the blade release mechanism 32 contributes to a more efficient and safer tool.

In an example, the utility knife includes a squeeze handle 36 to deploy the blade 19 of the utility knife. In an example, the squeeze handle 36 allows the user to deploy the blade 19 by applying pressure. This ergonomic design provides a convenient and intuitive way to extend the blade 19, making it easier and quicker to use. The squeeze handle 36 is particularly beneficial in situations where the user needs to frequently extend and retract the blade 19, as it reduces the effort required for these actions.

The squeeze handle 36 is designed to provide a comfortable grip, reducing hand fatigue during prolonged use. It also offers precise control over blade 19 deployment, allowing the user to adjust the blade length as needed. This enhances the overall usability and efficiency of the tool, making it more suitable for various tasks.

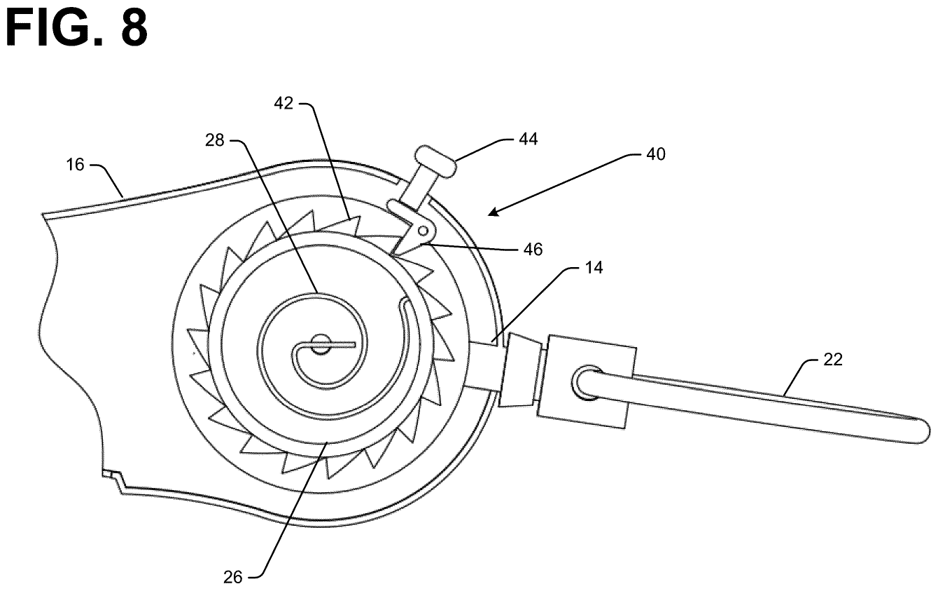

FIG. 8 shows another example retraction mechanism 40 for the example device 10. The retraction mechanism 40 is shown in FIG. 8 as it may be implemented as a ratcheting braking system and payout mechanism. The ratchet 42 provides precise control over the lanyard's extension and retraction, and holds the lanyard 14 at the desired length, thereby enhancing safety and convenience. The payout mechanism may include a spring-loaded drum (e.g., spring 28, previously described) with a toothed or ratcheting mechanism 42 that allows the lanyard 14 to be unspooled under slight tension during normal movement, but automatically engages a braking system including release trigger 44 and engagement 46 to prevent the lanyard 14 from being retracted during use. The retraction spring 28 ensures that the lanyard 14 remains taut, preventing slack and maintaining a neat appearance during use, and can be manually released (e.g., via release trigger 44) for retraction onto the reel 26 when the device 10 is no longer in use. These enhanced features make the device 10 more practical and user-friendly, catering to the needs of professionals in various fields.

When the user pulls the lanyard, the tension spring 28 inside the reel 26 is stretched, and the ratchet mechanism 40 engages to prevent the lanyard 14 from retracting immediately. This ratchet mechanism 40 has teeth 42 that lock into place, holding the lanyard 14 at the desired length. When the user finishes using the lanyard 14 and no longer needs it extended, they can manually release the ratchet mechanism 40 by operating the release trigger 44 to disengage the engagement 46 from the teeth 42 of the ratchet mechanism 40, allowing the tension spring to automatically spool the lanyard 14 back onto the reel 26. The stored energy in the spring 28 causes the reel 26 to retract the lanyard 14 smoothly and efficiently, ensuring it is neatly stored and ready for the next use. This ensures that the lanyard 14 is both easily extendable and retractable, providing convenience and organization.

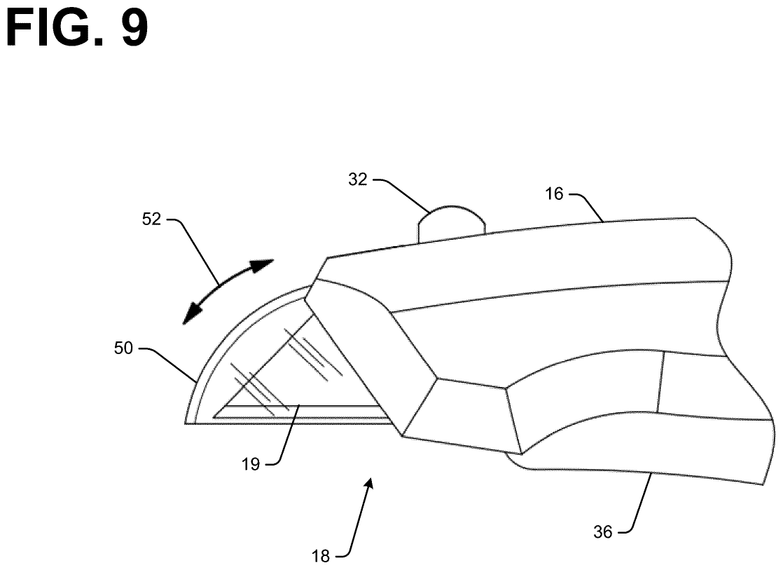

FIG. 9 shows an example hood mechanism 50 for the device 10. In an example, the utility knife 12 includes a safety hood 50 in the tool body 16 provided adjacent to the blade 19 of the utility knife. The inclusion of the safety hood 50 adjacent to the blade 19 provides an added layer of protection. The hood 50 helps prevent accidental contact with the blade, reducing the risk of injury. It is particularly useful in busy or hazardous working environments where accidental cuts are a concern. The safety hood 50 can also serve to protect the blade when not in use, extending its lifespan by shielding it from damage.

In an example, the safety hood 50 (e.g., made of transparent or semi-transparent plastic) retracts from above the blade 19 and, when the utility blade is not in use, the guard extends in order to protect the user. The safety hood 50 is designed to be easily movable or retractable, as illustrated by arrows 52, for example by being spring loaded to default to the closed position over the blade 19, and open automatically during use as the user presses the blade into the object to be cut. This helps ensure that the hood 40 does not interfere with the tool's operation or require additional steps by the user to implement. It provides a balance between safety and functionality, making the device 10 more user-friendly and secure.

It is noted that the examples shown and described are provided for purposes of illustration and are not intended to be limiting. Still other examples are also contemplated.

1. A tool with retractable lanyard, comprising:
a tool body having an operating end and a handle end;
a reel associated with the tool body;
a self-retracting mechanism of the reel;
a lanyard configured to at least partially unspool from the reel as the tool body is pulled away from the reel thereby applying tension to the lanyard, and to at least partially spool back onto the reel automatically when the tension applied to the lanyard is lessened or fully released; and
an attachment mechanism on the lanyard configured to associate the tool body with a person or article associated with the person via the lanyard so that the person can readily locate the tool body for use without having to search for the tool body.

2. The tool of claim 1, wherein the tool body is a utility knife, and the operating end is a blade of the utility knife.

3. The tool of claim 2, further comprising a blade release on the tool body.

4. The tool of claim 2, further comprising a squeeze handle to deploy the blade of the utility knife.

5. The tool of claim 3, further comprising a safety hood on the tool body adjacent to the blade of the utility knife.

6. The tool with retractable lanyard of claim 1, wherein the lanyard has a length configured to permit the attachment mechanism to remain connected to the person or article associated with the person while the person uses the tool.

7. The tool with retractable lanyard of claim 1, wherein the lanyard is provided inside of the tool body and an end of the lanyard extends out from within the tool body.

8. The tool of claim 1, wherein the attachment mechanism is a ring.

9. The tool of claim 1, wherein the attachment mechanism is a clip.

10. The tool of claim 1, wherein the article associated with the person is a ladder or other stationary or semi-stationary object near the person.

11. The tool of claim 1, wherein the article associated with the person is a clothing article worn by the person.

12. The tool of claim 1, wherein the lanyard is a coiled line.

13. The tool of claim 1, wherein the self-retracting mechanism has a spring roller.

14. The tool of claim 1, wherein the self-retracting mechanism has a braking system to prevent the lanyard from retracting during use, the braking system releasable by the person after using the tool.

15. The tool of claim 1, wherein the self-retracting mechanism has a payout mechanism that allows the lanyard to be unspooled under tension.

16. The tool of claim 1, wherein the payout mechanism has a spring-loaded drum with a ratcheting mechanism.

17. The tool of claim 1, wherein the self-retracting mechanism has a retraction spring configured to keep the lanyard taught as the lanyard moves in and out of the tool body.

18. A utility knife tool with retractable lanyard, comprising:
a tool body having a handle and a blade;
a reel associated with the tool body;
a self-retracting mechanism of the reel;
a lanyard on the reel, the lanyard configured to at least partially unspool from the reel as the tool body is pulled away from the reel thereby applying tension to the lanyard, and the lanyard configured to at least partially spool back onto the reel automatically when the tension applied to the lanyard is lessened or fully released; and
an attachment mechanism on the lanyard configured to connect the tool body to an article associated with a person via the lanyard so that the person can readily locate the tool body for use without having to search for the tool body.

19. The tool of claim 18, further comprising:
a blade release on the tool body; and
a squeeze handle to deploy the blade of the utility knife.

20. The tool of claim 18, further comprising a safety hood on the tool body adjacent to the blade of the utility knife.
